(19) United States
(12) Patent Application Publication
(10) Pub. No.: US 2026/0006390 A1
(43) Pub. Date: Jan. 1, 2026

(54) HEARING AID SYSTEM FOR DETERMINING AN AUDIO SIGNAL OF INTEREST

(71) Applicant: Oticon A/S, Smorum (DK)

(72) Inventors: Vasudha SATHYAPRIYAN, Smørum (DK); Svend FELDT, Ballerup (DK); Michael Syskind PEDERSEN, Smørum (DK); Jesper JENSEN, Smørum (DK)

(21) Appl. No.: 19/216,813

(22) Filed: May 23, 2025

(30) Foreign Application Priority Data
Jun. 28, 2024 (EP) 24185393.6

(51) Int. Cl. H04R 25/00

(52) U.S. Cl. CPC H04R 25/40; H04R 2225/41; H04R 2225/51

(57) ABSTRACT

Disclosed herein are embodiments of a hearing aid system. The hearing aid system can include a hearing aid configured to be worn by a user. A remote input unit can be configured to provide a remote audio signal. One or more processing units can be configured to obtain the plurality of local input audio signals, obtain the remote audio signal, beamform the plurality of local input audio signals to determine a front-facing beamformed signal, and determine a prime candidate signal based on the front-facing beamformed signal and the remote audio signal.

### TECHNICAL FIELD

The present application relates to the field of hearing aids.

### BACKGROUND

Speech enhancement (SE) and noise suppression in hearing aids (HAs) can be assisted using external/remote microphones (RMs), which are wirelessly connected to the HAs. The RMs pick up sound, potentially process it, before it is transmitted to the HAs, which typically would process the sound signal further, e.g., by combining it with the sound signals picked up by the HA microphones, apply hearing loss compensation, incl. amplification and compression, etc.

The RMs have the advantage that they may be located closer to the target sound source than the HA microphones, and, hence, be able to pick up the target sound at a better signal-to-noise ratio (SNR) than what would be possible with the HA mics. Furthermore, the RMs may consist of more microphones and may be equipped with more processing capabilities than is possible with body-worn devices such as HAs.

A typical setup where RMs could be useful is a dinner party situation, where participants are sitting around a table, the RMs could be located on the table between the dinner party participants, which would reduce the distance (and, hence, increase the SNR) wrt. potential conversation partners. However, a vital question arises when an RM signal is utilized what is the candidate signal of interest to the user?

The applicant has already provided one possible solution to this issue in EP 3 716 642 A2, which disclose a hearing system comprising a) at least one hearing device adapted for being worn on the head, or fully or partially implanted in the head, of a user, and b) a multitude of external, spatially separated, audio transmitters, each providing respective external electric sound signals comprising audio. The hearing system is configured to allow wireless communication, including audio communication, between said hearing device and said external audio transmitters, at least from said external audio transmitters to said at least one hearing device, to be established. The at least one hearing device comprises A) a multitude of microphones, each providing an electric input signal representative of sound; B) a beamformer filter providing a beamformed signal from said multitude of electric input signals; and C) an output unit configured to provide stimuli perceivable by the user as sound. The hearing system further comprises c) a selector/mixer for selecting and possibly mixing one or more of said electric input signals or said beamformed signal from the hearing device and said external electric signals from the audio transmitters and to provide a current input sound signal based thereon intended for being presented to the user, possibly in a further processed form. The selector/mixer is controlled by a source selection control signal provided by a source selection processor. The source selection processor is configured to determine said source selection control signal in dependence of a comparison of said beamformed signal and said external electric sound signals or processed versions thereof.

Consequently, it is a goal of the present disclosure to provide an alternative bearing system for determining a candidate signal of interest to a user.

### SUMMARY

In a first aspect of the present disclosure, Error! Reference source not found. system is provided. The hearing aid system comprises a hearing aid configured to be worn by a user. The hearing aid comprises a local input interface configured to provide a plurality of local input audio signals, an output interface configured to output an output audio signal to the user, and a local communication interface configured to wirelessly transmit and receive signals. The hearing aid system comprises a remote input unit. The remote input unit comprises a remote input interface configured to provide a remote audio signal, and a remote communication interface configured to wirelessly transmit and receive signals. The hearing aid system comprises one or more processing units. The one or more processing units are configured to obtain the plurality of local input audio signals. The one or more processing units are configured to obtain the remote audio signal. The one or more processing units are configured to beamform the plurality of local input audio signals to determine a front-facing beamformed signal. The front-facing beamformed signal is configured to focus on sound coming from a direction which the user of the hearing aid is facing. The one or more processing units are configured to determine a prime candidate signal based on the front-facing beamformed signal and the remote audio signal. The prime candidate signal is a source separated audio signal derived from the remote audio signal and determined based on a similarity measure with the front-facing beamformed signal.

The present invention works under the assumption that user of a hearing aid will point their head towards a signal of interest, thus, allowing the front-facing beamformed signal to be used as a similarity criterion for selection of the prime candidate signal. By having the prime candidate signal being a source separated signal may allow for the signal to better reflect what the user of the hearing aid is interested in while discarding unnecessary background noise, thus, facilitating improved focus for the hearing aid user. Furthermore, it may facilitate better diagnostic and an improved output signal if the prime candidate signal is utilized in further processing by either the hearing aid or another device.

The hearing aid system may comprise several hearing aids distributed over several different users. The hearing aid system may comprise several remote input units. The remote units may be arranged at separate locations.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a local processing unit for enhancing the input signals and providing a processed output signal. Some or all signal processing performed by the local processing unit may be conducted in the frequency domain, in which case the hearing aid comprises appropriate analysis and synthesis filter banks. Some or all signal processing performed by the local processing unit may be conducted in the time domain.

The local input interface may be for providing an electric input signal representing sound. The local input interface may comprise an input transducer, e.g., a microphone, for converting an input sound to an electric input signal. The local input interface may comprise a plurality of input transducers, e.g., a plurality of microphones, configured to provide a plurality of local input audio signals.

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in several ways, as e.g., described in the prior art. In hearing aids, a microphone array beamformer is often used for spatially attenuating background noise sources. The beamformer may comprise a linear constraint minimum variance (LCMV) beamformer, Many beamformer variants can be found in literature. The minimum variance distortionless response (MVDR) beamformer is widely used in microphone array signal processing. Ideally the MVDR bearformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

The output interface may be for providing a stimulus perceived by the user as an acoustic signal based on a processed electric signal. The output interface may be a vibrator of a bone conducting hearing aid. The output interface may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user.

The local communication interface may comprise an antenna, thus, allowing the hearing aid to wirelessly transmit and receive signals. The local communication interface be configured to receive and/or transmit an electromagnetic signal in the radio frequency range (3 kHz to 300 GHz).

The local communication interface may comprise antenna and transceiver circuitry allowing a wireless link to an entertainment device (e.g., a TV-set), a communication device (e.g., a telephone), a wireless microphone, a separate (external) processing device, or another hearing aid, etc. The hearing aid may be configured to wirelessly receive a signal from another device. Likewise, the hearing aid may be configured to wirelessly transmit a signal to another device. The signal transmitted or received may represent or comprise an audio signal and/or a control signal and/or an information signal.

The signal received or transmitted by the hearing aid may be an audio signal and/or a control signal and/or an information signal.

In general, a wireless link established by the local communication interface of the hearing aid can be of any type. The wireless link may be a link based on near-field communication, e.g., an inductive link based on an inductive coupling between antenna coils of transmitter and receiver parts. The wireless link may be based on far-field, electromagnetic radiation.

Preferably, frequencies used to establish a communication link between the hearing aid and the other device is below 70 GHz, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra-(UWB) technology.

The hearing aid may comprise an analogue-to-digital (AD) converter to digitize an analogue input (e.g., from an input transducer, such as a microphone) with a predefined sampling rate, e.g., 20 kHz. The hearing aid may comprise a digital-to-analogue (DA) converter to convert a digital signal to an analogue output signal, e.g., for being presented to a user via an output transducer.

The hearing aid may comprise a voice activity sensor (VAD) for estimating whether (or with what probability) an input signal comprises a voice signal (at a given point in time). A voice signal may in the present context be taken to include a speech signal from a human being. It may also include other forms of utterances generated by the human speech system (e.g., singing). The voice activity sensor unit may be adapted to classify a current acoustic environment of the user as a VOICE or NO-VOICE environment. This has the advantage that time segments of the electric microphone signal comprising human utterances (e.g. speech) in the user's environment can be identified, and thus separated from time segments only (or mainly) comprising other sound sources (e.g. artificially generated noise). The voice activity sensor may be adapted to detect as a VOICE also the user's own voice. Alternatively, the voice activity sensor may be adapted to exclude a user's own voice from the detection of a VOICE.

The hearing aid may comprise an own voice sensor for estimating whether (or with what probability) a given input sound (e.g. a voice, e.g. speech) originates from the voice of the user of the system. A microphone system of the hearing aid may be adapted to be able to differentiate between a user's own voice and another person's voice and possibly from NON-voice sounds. clai

[symbol]

The remote input unit may be adapted to provide a frequency dependent gain and/or a level dependent compression and/or a transposition (with or without frequency compression) of one or more frequency ranges to one or more other frequency ranges, e.g. to enhance an audio signal. The remote input unit may comprise a remote processing unit for enhancing the input signals and providing a processed output signal. Some or all signal processing performed by the remote processing unit may be conducted in the frequency domain, in which case the hearing aid comprises appropriate analysis and synthesis filter banks. Some or all signal processing performed by the remote processing unit may be conducted in the time domain.

The remote input interface may be for providing an electric input signal representing sound. The remote input interface may comprise an input transducer, e.g., a microphone, for converting an input sound to an electric input signal. The remote input interface may comprise a plurality of input transducers, e.g., a plurality of microphones, configured to provide a plurality of local input audio signals.

The remote communication interface may comprise an antenna, thus, allowing the hearing aid to wirelessly transmit and receive signals. The remote communication interface be configured to receive and/or transmit an electromagnetic signal in the radio frequency range (3 kHz to 300 GHz).

The remote communication interface may comprise antenna and transceiver circuitry allowing a wireless link to the hearing aid, an entertainment device (e.g., a TV-set), a communication device (e.g., a telephone), a wireless microphone, a separate (external) processing device, or another hearing aid, etc. The remote input unit may be configured to wirelessly receive a signal from another device. Likewise, the remote input unit may be configured to wirelessly transmit a signal to another device. The signal transmitted or received may represent or comprise an audio signal and/or a control signal and/or an information signal.

The signal received or transmitted by the remote input unit may be an audio signal and/or a control signal and/or an information signal.

The remote input unit and the hearing aid may be communicatively connected to allow for signals to be transmitted from the hearing aid to the remote input unit and vice versa. The signals transmitted between the remote input unit and the hearing aid may be audio signals, control signals, and/or information signals. The remote input unit and the hearing aid may be communicatively connected by a wireless link. The remote input unit and the hearing aid may be communicatively connected by a wired connection.

The one or more processing units may comprise one or more local processing units comprised by the hearing aid. The one or more processing units may comprise one or more remote processing units comprised by the remote input unit. The one or more processing units may comprise one or more remote processing units comprised by the remote input unit and one or more local processing units comprised by the hearing aid. The one or more processing units may comprise one or more external processing units comprised by an external processing device. The processing performed by the one or more processing units may be distributed over different processing units comprised by different devices, for example part of the processing performed may be performed by one or more local processing units comprised by the hearing aid, and another part may be performed by one or more remote processing unit comprised by the remote input unit. Distributing the processing may be advantageous to free up processing power at the hearing aid for other tasks. A processed signal determined by the one or local processing units may be transmitted to the one or more remote processing units for further processing and vice versa.

The one or more processing unit are configured to obtain the plurality of local input audio signals. The one or more processing units may obtain the plurality of local input audio signals by receiving them as wireless signals, e.g., if the one or more processing units are comprised by the remote input unit or an external processing device obtaining the plurality of local input audio signal may comprise receiving them via a wireless link with the hearing aid. The one or more processing units may obtain the plurality of local input audio signals directly from the local input interface of the hearing aid, e.g., if the one or more processing units are comprised by the hearing aid, the one or more processing units may obtain the plurality of local input audio signal directly from the local input interface.

The one or more processing unit are configured to obtain the remote input audio signal. The one or more processing units may obtain the remote input audio signals by receiving them as wireless signals, e.g., if the one or more processing units are comprised by the hearing aid obtaining the plurality of local input audio signal may comprise receiving them via a wireless link with the remote input unit. The one or more processing units may obtain the plurality of local input audio signals directly from the remote input interface, e.g., if the one or more processing units are comprised by the remote input unit, the one or more processing units may obtain the remote input audio signal directly from the remote input interface.

The one or more processing units are configured to beamform the plurality of local input audio signals to determine a front-facing beamformed signal. Beamforming of the plurality of local input audio signals may comprise applying a linear constraint minimum variance (LCMV) beamformer. Beamforming of the plurality of local input audio signals may comprise applying a minimum power distortionless response (MPDR) beamformer. Beamforming of the plurality of local input audio signals may comprise applying a minimum variance distortionless response (MVDR) beamformer. Ideally the MVDR beamformer keeps the signals from a target direction unchanged, while attenuating sound signals from other directions maximally. Beamforming of the plurality of local input audio signals may be done by a fixed beamformer, i.e., by a beamformer where the beamformer weights are predetermined and are not adapted based on the plurality of local input audio signals. Beamforming of the plurality of local input audio signals may be done by an adaptive beamformer, i.e., by a beamformer where the beamformer weights are adapted based on the plurality of local input audio signals.

In the present disclosure, the front-facing beamformed signal may be understood as an audio signal configured to focus on sound coming from a direction which the user of the hearing aid is facing. The focusing of the sound may be achieved in multiple ways, e.g., attenuating sound from other directions, enhancing sound from the desired directions, etc. The front-facing beamformed signal may be achieved by a fixed beamformer where beamforming weights have been predetermined such that a main lobe of the beamformer is along a direction which the user of the hearing aid is facing while wearing the hearing aid. The beamformer weights may be predetermined by an audio engineer, an audiologist, or in a factory setting. The front-facing beamformed signal may be achieved by an adaptive beamformer where beamforming weights are only adapted to sound coming from a direction which the user of the hearing aid is facing while wearing the hearing aid. To assist the adaptive beamformer a direction of arrival (DoA) algorithm may be utilized. The DoA algorithm may determine whether sound is coming from a direction which the user of the hearing aid is facing, and thus determine whether the adaptive beamformer should adapt to the in-coming sound.

Beamforming of the plurality of local input audio signals to determine the front-facing beamformed signal may be performed by one or more local processing units comprised by the hearing aid. The one or more local processing unit may determine the front-facing beamformed signal and transmit the front-facing beamformed signal. The one or more local processing units may transmit the front-facing beamformed signal to one or more remote processing units for further processing.

The prime candidate signal is a source separated audio signal derived from the remote audio. In situation where only a single remote audio signal is obtained the prime candidate signal may be found from a signal separation algorithm, e.g., DNN-based, Independent-Component-Analysis (ICA) based D. Mika, G. Budzik, J. Józwik, “Single Channel Source Separation with ICA-Based Time-Frequency Decomposition,” Sensors (Basel). 2020 April, or other algorithms for decomposing sound signals into basic constituents D.-L. Wang, J. Chen, “Supervised Speech Separation Based on Deep Learning,” https://arxiv.org/pdf/1708.07524, 2017. In embodiments where a plurality of remote audio signals is provided by the remote input unit source separation may be conducted by beamforming or other multichannel processing. The beamformers could—for example—be standard beamformers steered in pre-defined directions, e.g., MVDR beamformers, MPDR beamformers, MWF beamformers, LCMV beamformers, cf. J. Benesty, “Microphone Array Signal Processing,” Springer 2008. Beamforming of the plurality of remote audio signal may be carried out by neural beamformers, i.e., beamformers whose coefficients are determined using a (deep) neural network (DNN) G. Li, s. Lian, S. Nie, W. Liu, Z. Yang, “Deep neural network-based generalized sidelobe canceller for dual-channel far-field speech recognition”, Neural Networks, Vol. 131, pp. 225-237, 2021, or whose output signal is simply an output of a DNN Y. Xu et al., “Neural Spatio-Temporal Beamformer for Target Speech Separation,” Proc. Interspeech 2020.

The prime candidate signal is determined based on a similarity measure with the front-facing beamformed signal and the prime candidate signal. The similarity measure with the front-facing beamformed signal and the prime candidate signal may be understood as the prime candidate signal being determined by using the similarity to the front-facing beamformed signal as an optimization criterion. In the above-mentioned algorithms, several candidate signals may be determined, however, not all of these are of interest to the user of the hearing aid. If several candidate signals are determined based on the remote audio signal or a plurality of remote audio signal, the candidate signal resulting in the highest resulting similarity measure with the front-facing beamformed signal may be determined as the prime candidate signal. Mathematically this may be formulated as:

$${i}^{*} = arg {max}_{i} S ( {B}_{i} ( n ) , Z ( n ) )$$

Where Z(n) is the front-facing beamformed signal and Bᵢ(n) is the i'th candidate signal, S(·) is a similarity measure, and n is a time index.

The similarity may be determined by any function which determines the difference between two signals. Such measures may for example be found in Loizou, P.C. (2007). Speech Enhancement: Theory and Practice (1st ed.). CRC Press. The similarity could for example be determined as the correlation between the signals. The similarity may be determined by the linear correlation coefficient between the two signals. The similarity may be determined the sum of correlations of sub band signals (arising from a frequency decomposition of Bᵢ(n) and Z(n)), etc. The similarity could be determined based on intelligibility metrics such as STOI, ESTOI, STGI, etc. or quality metrics such PESQ, POLQA, etc., or other measures, including scale-invariant signal-to-distortion-ratio (SI-SDR), etc.

The one or more processing units are configured to determine a prime candidate signal based on the front-facing beamformed signal and the remote audio signal. The one or more processing units may determine the prime candidate signal in a plethora of different manner, in the following description several different examples are provided for how the prime candidate signal may be determined based on the front-facing beamformed signal and the remote audio signal.

In an embodiment the front-facing beamformed signal may be used solely for determining the prime candidate signal. As the front-facing beamformed signal does not need to be presented to a user, processing latency is not an issue. This has several advantages, for example that the front-facing beamformer can operate with a higher frequency resolution than typical beamformers which are listened to by the user of the hearing aid. In some embodiments the front-facing beamformed signal may be presented to a user of the hearing aid.

The remote input unit may be a stationary unit such as a microphone array installed into a meeting room. The remote input unit may be a movable unit such as a table-microphone array, a mobile phone, a laptop, a conference microphone bar, a smart speaker, a wristwatch, etc.

In the above it is stated that a prime candidate signal is selected. In some embodiments a plurality of prime candidate signals may be determined. The plurality of prime candidate signals could for example be a subset of signals from a larger set of candidate signals determined by a source separation algorithm. The subset may be determined by determining a similarity measure for each candidate signal and then comparing it to a threshold value. The subset may be determined by ranking the determined candidate signal according to their similarity measure, and then taking the M highest ranked signals, e.g., M=2, 3, 4, or 5.

In an embodiment the hearing aid system comprises a first hearing aid configured to be worn at a first ear and a second hearing aid configured to be worn at a second ear of the user. The first hearing aid comprises a first local input interface configured to provide a plurality of first local input audio signals, a first output interface configured to output a first output audio signal to the user, and a first local communication interface configured to wirelessly transmit and obtain signals. The second hearing aid comprises a second local input interface configured to provide a plurality of second local input audio signals, a second output interface configured to output a second output audio signal, and a second local communication interface configured to wirelessly transmit and obtain signals. The one or more processing units are configured to obtain the plurality of first local input audio signals, The one or more processing units are configured to obtain the plurality of second local input audio signals. The one or more processing units are configured to binaurally beamform the plurality of first local input audio signals and the plurality of second local input audio signals to determine the front-facing beamformed signal.

By binaurally beamforming the plurality of audio signals from both hearing aids a better directionality of the front-facing beamformed signal may be achieved. In particular, the front-facing beamformed signal may be determined by a binaural beamformer utilizing microphone signals from both left and right hearing instrument, hereby obtaining a better directionality as compared to a traditional beamformed signal.

The first hearing aid may comprise one or more first local processing units. The second hearing aid may comprise one or more second local processing units.

The plurality of first local input audio signals may be obtained by one or more first local processing units comprised by the first hearing aid. The one or more first local processing units may obtain the plurality of first local input audio signals from the first local input interface. The plurality of second local input audio signals may be obtained by one or more first local processing units comprised by the first hearing aid. The one or more first local processing units may obtain the plurality of second local input audio signals from the second hearing aid via a wireless link between the first local communication interface and the second local communication interface.

The plurality of second local input audio signals may be obtained by one or more second local processing units comprised by the second hearing aid. The one or more second local processing units may obtain the plurality of second local input audio signals from the second local input interface. The plurality of first local input audio signals may be obtained by one or more second local processing units comprised by the second hearing aid. The one or more second local processing units may obtain the plurality of first local input audio signals from the first bearing aid via a wireless link between the first local communication interface and the second local communication interface.

The plurality of second local input audio signals and the plurality of first local input audio signals may be obtained by one or more remote processing units comprised by the remote input unit. The one or more remote processing units may obtain the plurality of second local input audio signals via a wireless link between the second local communication interface and the remote communication interface. The one or more remote processing units may obtain the plurality of first local input audio signals via a wireless link between the first local communication interface and the remote communication interface.

Beamforming of the plurality of first local input audio signals and the plurality of second local input audio signals to determine the front-facing beamformed signal may be done by the one or more first local processing units. Beamforming of the plurality of first local input audio signals and the plurality of second local input audio signals to determine the front-facing beamformed signal may be done by the one or more second local processing units. Beamforming of the plurality of first local input audio signals and the plurality of second local input audio signals to determine the front-facing beamformed signal may be done by the one or more remote processing units. The front-facing beamformed signal may be determined by the one or more first local processing units and subsequently transmitted to the one or more remote processing units for further processing or vice versa. The front-facing beamformed signal may be determined by the one or more second local processing units and subsequently transmitted to the one or more remote processing units for further processing or vice versa.

In an embodiment the hearing aid comprises one or more local processing units. The one or more local processing units are configured to beamform the plurality of local input audio signals to determine the front-facing beamformed signal. The one or more local processing unit are configured to down-sample the front-facing beamformed signal. The one or more local processing unit are configured to, subsequent to down-sampling of the front-facing beamformed signal, transmit the front-facing beamformed signal to one or more remote processing units. The remote input unit comprises the one or more remote processing units. The one or more remote processing units are configured to obtain the remote audio signal. The one or more remote processing unit are configured to obtain the down-sampled front-facing beamformed signal. The one or more remote processing units are configured to determine the prime candidate signal.

As the purpose of the front-facing beamformed signal may only be to determine a similarity measure to thereby determine a prime candidate signal, maintaining the quality of the signal may not be necessary thus allowing for down sampling of the signal while transmitting it, thereby, saving bandwidth.

Down sampling of the front-facing beamformed signal may comprise down-sampling the front-facing beamformed signal below a critical sample rate, e.g., beyond the Nyquist rate.

In an embodiment the one or more processing units are configured to source separate the remote input audio signal to determine a plurality of candidate signals. The one or more processing units are configured to determine for each candidate signal a similarity measure between the respective candidate signal and the front-facing beamformed signal. The one or more processing units are configured to determine the prime candidate signal from the plurality of candidate signals based on the plurality of similarity measures.

The prime candidate signal may be determined as one of the determined candidate signals, e.g., the candidate signal with the highest similarity measure to the front-facing beamformed signal. The prime candidate signal may be determined as a combination of the candidate signals. Determining the prime candidate signal as a combination of candidate signals may be advantageous in situations where several candidate sound sources are present in the user's front beam-facing beamformed signal, and it is hard to identify the target source of interest with certainty. A combination of the candidate signals may be a function of their respective similarity measure. The combination may be determined as a linear combination.

$${B}_{lin - comb} ( n ) = {\sum }_{i} {α}_{i} {B}_{i} ( n )$$

Where B_{lin-comb}(n) is the linear combination a, is a weighting coefficient determined as a function of the similarity measure associated with the respective candidate signal Bᵢ(n).

The plurality of candidate signals may be determined at one or more local processing units comprised by the hearing aid. The plurality of candidate signals may be determined at one or more remote processing units comprised by the remote input unit. After the plurality of candidate signals have been determined, they may be transmitted to another processing unit to undergo further processing or be further processed at the same processing unit.

The plurality of similarity measures between the candidate signals and the front facing beamformed signal may be determined at one or more local processing units comprised by the hearing aid. The plurality of similarity measures between the candidate signals and the front facing beamformed signal may be determined at one or more remote processing units comprised by the remote input unit. After the plurality of similarity measures have been determined, they may be transmitted to another processing unit to undergo further processing or be further processed at the same processing unit.

In a multi speaker scenario where several speakers are speaking simultaneously or near simultaneously several candidate signals may be determined as a result of a source separation process. An estimate of each speaker signal may be extracted by a source separation algorithm, each speaker signal may then be a candidate signal from which a prime candidate signal may be determined. The remote input unit may be configured to provide a plurality of remote audio signals. The plurality of candidate signals may be determined by an adaptive beamformer algorithm based on the plurality of remote audio signals.

In an embodiment the remote input unit is configured to provide a plurality of remote audio signals. The one or more processing units are configured to obtain the plurality of remote audio signals. The one or more processing units are configured source separate the plurality of remote audio signals by decomposing the plurality of remote audio signals using a spatial filter bank.

The one or more processing unit may decompose the plurality of remote audio signal using a spatial filter bank. The spatial filter bank may comprise a plurality of beamformers. The plurality of beamformer may each have a different target direction, i.e., a direction in which they are configured to pick-up sound while attenuating sound from other directions. The plurality of beamformer may each provide a candidate signals, e.g., denoted as B1(n), B2(n) . . . The front faced beamformed signal may be denoted as Z(n). A similarity measure between two signals may be denoted as S(·). The one or more processing units may then determine the prime candidate signals by applying the following formula:

$${i}^{*} = arg {max}_{i} S ( {B}_{i} ( n ) , Z ( n ) ) ,$$

The spatial filter bank may comprise a plurality of fixed beamformers each having a defined target direction.

In an embodiment the one or more processing units are configured to determine for each candidate signal a plurality of similarity measures between the respective candidate signal and the front-facing beamformed signal. The plurality of similarity measures is determined by temporally shifting the front facing beamformed signal relative to the candidate signal a plurality of times and for each shift determining the similarity measure.

Since the remote input unit is placed at a different location than the hearing aid, the time of flight for the plurality of local input audio signals and the plurality of remote input audio signals will be different, consequently, the remote audio signals and the local audio signal may not be properly synchronized with each other, this issue may further be exacerbated by processing being performed on the signals at the hearing aid and/or the remote input unit. Consequently, the similarity measure determined needs to compensate for the time difference of the signals. To compensate for the lack of synchronicity several time shifted similarity measures may be determined for each candidate signal, thus, the resulting similarity for each candidate signal may formulated as:

$$S ( {B}_{i} ( n ) , Z ( n ) ) = arg {max}_{l} {S}^{′} ( {B}_{i} ( n + l ) , Z ( n ) ) ,$$

where S′(·) is a similarity measure (identical to or different from S(·)), i.e., the similarity between two signals defined from the temporal shift l of the candidate signal Bᵢ((n) wrt. the front facing beamformed signal Z(n) that leads to maximum similarity. l may be selected as series of plausible time lags between the candidate signal and the front-facing beam formed signal, e.g., l={0, ±0.1lₘₐₓ±0.2lₘₐₓ, . . . , ±lₘₐₓ}, where, for example, lₘₐₓ=θₛ*0.040, where ƒₛ denotes the sampling frequency.

In an embodiment the one or more processing units are configured to determine for each candidate signal the similarity measure between the candidate signal and the front-facing beamformed signal by determining a correlation measure between the respective candidate signal and the front-facing beamformed signal.

In an embodiment the one or more processing units are configured to determine a local audio quality measure of the front-facing beamformed signal. The one or more processing units are configured to determine a remote audio quality for each candidate signal. The one or more processing units are configured to determine for each candidate signal the similarity measure between the respective candidate signal and the front-facing beamformed signal by comparing the local audio quality measure with the respective remote audio quality measure.

The remote audio quality measure and the local audio quality measure could be based on intelligibility metrics such as STOI, ESTOI, STGI, etc. or quality metrics such PESQ, POLQA, etc., or other measures, including scale-invariant signal-to-distortion-ratio (SI-SDR), etc. Preferably, the remote audio quality measure and the local audio quality measure are measures of the same audio quality measure, thus, facilitating easy comparison between the two.

In an embodiment the one or more processing units are configured to determine a plurality of prime candidate signals from the plurality of candidate signals based on the similarity measures.

This may be advantageous in situations where several candidate signals with similar similarity S measures are present. The plurality of prime candidate signals may then be utilized for further processing.

In an embodiment the one or more processing unit are configured to output the plurality of prime candidate signal to the user of the hearing aid. The one or more processing units are configured to receive a user input from the user indicating a preferred prime candidate signal. The one or more processing units are configured to determine the preferred prime candidate signal based on the user input.

The plurality of prime candidate signals may be outputted to the user by the output interface of the hearing aid. The prime candidate signals may be output as audio signals to the user. The user may provide a user input to the one or more processing units via the hearing aid, e.g., via a button arranged on the hearing aid, or via an external device communicatively connected to the hearing aid, such as a smart device. The preferred prime candidate signal may be determined as the one selected by the user input.

The preferred candidate signal selected by the user input may then be utilized for further processing. The other determined prime candidate signals may be discarded.

In an embodiment the one or more processing unit are configured to combine the plurality of prime candidate signals to determine a combined prime candidate signal. The plurality of prime candidate signals being combined based on their respective similarity measure. The prime candidate signals may be linearly combined as such:

$${PB}_{lin - comb} ( n ) = {\sum }_{i} {α}_{i} {PB}_{i} ( n )$$

Where PB_{lin-comb}(n) is the linear combination αᵢ is a weighting coefficient determined as a function of the similarity measure associated with the respective prime candidate signal PBᵢ(n).

In an embodiment the one or more processing units are configured to determine the prime candidate signal by a neural network trained to source separate the remote audio signal. The neural network being configured to obtain the front-facing beamformed signal as an enrollment signal.

The neural network may be a neural beamformer, an example of such a system may be found in K. Žmolíková et al., “Speakerbeam: Speaker aware neural network for target speaker S extraction in speech mixtures,” IEEE Journal of Selected Topics in Signal Processing, No. 4, Vol. 13, pp. 800-814, 2019. Such a system may receive the front-facing beamformed signal as an enrollment signal, and thus be configured to determine a similar signal based on the remote audio input signal or the plurality of remote audio input signals. The enrollment signal in the present disclosure may be understood as a target signal for the neural network,

In an embodiment the system comprises a sensor configured to provide a sensor signal. The one or more processing units are configured to obtain the sensor signal. The one or more processing units are configured to determine the prime candidate signal based on the sensor signal.

In situations where several candidate sound sources might be located in front of the HA user, an approach utilizing only audio signal may not be sufficient to differentiate properly between the candidate sound sources. To alleviate this potential short-coming additional sensors may facilitate differentiation.

The sensor may be a biological sensor configured to measure a biological response of a user of the hearing aid, such as a temperature sensor, an EEG sensor, a pulse sensor, a sweat sensor, etc . . . The sensor may be a movement sensor configured to measure movement of a user of the hearing aid, such as an accelerometer, a gyroscope, an IMU, etc . . . The sensor may be a video sensor configured to capture one or more images.

The sensor may be comprised by the hearing aid, e.g., incorporated in a housing of the hearing aid.

The sensor signal provided by the sensor may facilitate determining the prime candidate signal among the candidate signals. For example, if the sensor is a movement sensor it may be configured to sense head movement of the user, such as head turn or nodding. The head movement may be used to indicate the target talker, e.g., if the user of hearing aid is nodding towards a specific direction, or if a change of target talker occurs, e.g., the user turning their head. For example, if the one or more processing units determine a change in speaker based on the sensor signal, an update parameter for determining the front-facing beamformed signal may be increased. signals derived from the HA user can help the distinction. If the sensor is a biological sensor configured to provide an EEG signal of the user of the hearing aid, the EEG signal may be used can help identify the sound signal amongst the candidate signals that the user pays attention, an example of this is provided in B. Holtze et al., “Ear-BEG Measures of Auditory Attention to Continuous Speech,” Frontiers in Neuroscience, Vol. 16, May 2022. If the sensor is an audio sensor configured to provide an audio signal the prime candidate signal may be identified as the one that best exhibits tum-taking behavior with the bearing aid user. The sensor signal may be used in conjunction with the similarity measure to reinforce the determination of the prime candidate signal made based on the similarity measure. In cases of several candidate signals having similar similarity measures to the front-facing beam formed signals, the sensor signal may be used to decide which of the candidate signal is the prime candidate signal.

In an embodiment the one or more processing units are configured to determine the output audio signal based on the prime candidate signal.

In some embodiments the prime candidate signal may be the output audio signal, i.e., after determining the prime candidate signal it may be output to the user of the hearing aid. The output audio signal may be a locally processed signal combined with the prime candidate signal. The locally processed signal may be a signal determined by the one or more local processing units based on the plurality of local audio signals. For example, the locally processed signal may be an enhanced signal processed according to a hearing profile of the user, alternatively or additional, the locally processed signal may be a signal having undergone feedback cancellation, noise reduction, echo control, etc . . . The combination may be based on an analysis of the locally processed signal, e.g., if a low signal to noise ratio is detected within certain bands of the locally processed signal, corresponding bands of the prime candidate signal may replace or be mixed into these bands. The mixing may be achieved by a weighted combination of the prime candidate signal and the locally processed signal.

In an embodiment the hearing aid system comprises a plurality of hearing aids configured to be worn by a plurality of users. The plurality of hearing aids each comprising a local input interface configured to provide a plurality of local input audio signals. The plurality of hearing aids each comprising an output interface configured to output an output audio signal to the user of the respective hearing aid. The plurality of hearing aids each comprising a local communication interface configured to wirelessly transmit and obtain signals. The one or more processing units are configured to obtain the plurality of local input audio signals from each of the plurality of hearing aids. The one or more processing units are configured to beamform each of the pluralities of local input audio signals to determine a plurality of front-facing beamformed signal. That is a front-facing beamformed signal for each respective hearing aid. The one or more processing units are configured to determine a prime candidate signal for each hearing aid based on the respective front-facing beamformed signals and the remote audio signal. Each prime candidate signal is a source separated audio signal derived from the remote audio signal and determined based on a similarity measure between the respective front-facing beamformed signal and the remote audio signal.

Thus, multiple bearing aid users may share the remote unit. The use cases and descriptions in prior sections extend naturally to the case of multiple users sharing the remote unit. A wireless link formed between the plurality of hearing aids and the remote unit may utilize a broadcasting functionality allowing multiple users to access and listen to the same streams. Such broadcasting functionality is among others included in the Bluetooth standard as part of the Low Energy Audio (LEA) standard.

One or more remote processing units comprised by the remote unit may be configured to determine a plurality of candidate signals. The remote unit may be configured to determine the plurality of candidate signals based on a spatial filter bank. The remote unit may be configured to determine the plurality of candidate signals based on a source separation algorithm. The determined candidate signals may be sent to each hearing aid, which may then determine the prime candidate signal based on their respective front-facing beamformed signals and the determined candidate signals. Alternatively, the plurality of front-facing beamformed signals may be determined at each respective hearing aid, and then transmitted to the remote unit. The remote unit may then for each front-facing beamformed signal determine a prime candidate signal based on the determined list of candidate signals.

If the remote unit receives the front-facing beamformed signals from the plurality of hearing aids, the remote input unit may determine a super list, where the superlist comprises both the candidate signals, and the front-facing beamformed signals. The remote unit may then determine the prime candidate signal for a hearing aid by selecting a signal from the superlist based on a similarity measure with the respective front-facing beamformed signal. Consequently, the prime candidate signals for one hearing aid may be another hearing aid's front-facing beamformed signal. A natural further extension is to let each hearing aid provide one or more candidate signals to the remote input unit. The candidate signal may be the user's own voice signal.

In an embodiment the hearing aid comprises one or more local processing units. The one or more local processing unit are configured to obtain the prime candidate signal. The one or more local processing unit are configured to determine the output audio signal based on the prime candidate signal.

The one or more local processing units may further process the prime candidate signal to determine the output audio signal. The one or more local processing units may determine the prime candidate signal to be the output audio signal, and thus no further processing of the prime candidate signal may be needed before it is output to the user of the hearing aid. The one or more local processing units may determine the output signal by mixing the prime candidate signal with an audio signal based on the one or more local audio signals.

The hearing aid system may further comprise other relevant functionality for the application in question, e.g. compression, noise reduction, etc.

The hearing aid may comprise a hearing instrument, e.g. a hearing instrument adapted for being located at the ear or fully or partially in the ear canal of a user.

In a second aspect of the present disclosure a method for determining sound signal of interest is disclosed. The method comprises obtaining a plurality of local input audio signals provided by a hearing aid. The method comprises obtaining a remote audio signal provided by a remote input unit. The method comprises beamforming the plurality of local input audio signals to determine a front-facing beamformed signal. The front-facing beamformed signal is determined to focus on sound coming from a direction which the user of the hearing aid is facing. The method comprises determining a prime candidate signal based on the front-facing beamformed signal and the remote audio signal. The prime candidate signal is a source separated audio signal derived from the remote audio signal and determined based on a similarity measure with the front-facing beamformed signal.

It is intended that some or all of the structural features of the device described above, in the ‘detailed description of embodiments’ or in the claims can be combined with embodiments of the method, when appropriately substituted by a corresponding process and vice versa. Embodiments of the method have the same advantages as the corresponding devices.

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the car canal or with an output transducer, e.g. a loudspeaker, arranged close to or in the car canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's bearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system) and used by a processing algorithm executed by the configurable signal processing circuit of the hearing aid.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically drawing of a hearing aid system according to an embodiment of the present disclosure.

FIG. 2 is a schematic drawing of a hearing aid system according to the present disclosure employed in a meeting situation.

FIG. 3 is a schematic drawing of another hearing aid system according to the present disclosure employed in a meeting situation.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The term ‘or a processed version thereof’ may e.g. cover such extracted features from an original audio signal. The term ‘or a processed version thereof’ may e.g. also cover an original audio signal that has been subject to a processing algorithm that applies gain or attenuation and/or delay to the original audio signal and this results in a modified audio signal (preferably enhanced in some sense, e.g. noise reduced relative to a target signal, or simply delayed).

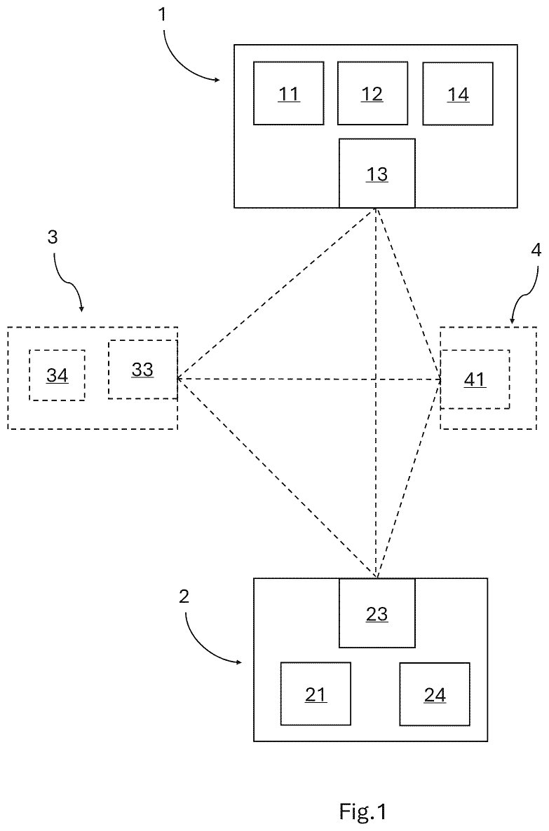

Referring initially to FIG. 1 showing a schematic drawing of a hearing aid system according to an embodiment of the present disclosure. The hearing aid system comprises a hearing aid 1. The hearing aid 1 is configured to be worn by a user. The hearing aid 1 comprises a local input interface 11. The local input interface 11 is configured to provide a plurality of local input. audio signals. The local input interface 11 may comprise one or more microphones. The local input interface 11 may comprise means for converting an analog electrical signal provided by the local input interface 11 into a digital signal. The hearing aid 1 comprises an output interface 12. The output interface 12 is configured to output an output audio signal to the user. The hearing aid comprises a local communication interface 13 configured to wirelessly transmit and receive signals. The hearing aid 1 comprises one or more local processing units 14. The one or more local processing units 14 may receive signals from the local communication interface 13 and/or the local input interface 11. The one or more local processing units 14 are configured to process a signal for provision of a processed signal. The one or more local processing units 14 are configured to process a signal received from the local communication. interface 13 and/or the local input interface 11. The processed signal may be sent to the local output interface 12 to be output as an output audio signal. The processed signal may be sent to the local communication interface 13 to be transmitted to another device.

The hearing aid system comprises a remote input unit 2. The remote input unit 2 comprises a remote input interface 21. The remote input interface 21 is configured to provide a remote input audio signal. The remote input interface 21 may comprise one or more microphones. The remote input interface 21 may comprise means for converting an analog electrical signal provided by the remote input interface 21 into a digital signal. The remote input unit 2 comprises a remote communication interface 23 configured to wirelessly transmit and receive signals. The remote input unit 2 comprises one or more remote processing units 24. The one or more remote processing units 24 may receive signals from the remote communication interface 23 and/or the remote input interface 21. The one or more remote processing units 24 are configured to process a signal for provision of a processed signal. The one or more remote processing units 24 are configured to process a signal received from the remote communication interface 23 and/or the remote input interface 21. The processed signal may be sent to the remote communication Interface 23 to be transmitted to another device.

The hearing aid system may comprise one or external processing units 3. The one or more external processing units may comprise an external communication interface 33 configured to wirelessly transmit and receive signals. The one or more external processing units may comprise one or more external processing units 33 configured to configured to process a signal for provision of a processed signal. The external processing unit 3 may be an additional hearing aid or an additional remote input unit.

The hearing aid 1 may be wirelessly connected to the remote input unit 2 to allow audio signals, control signals and/or information signals to be communicated between the hearing aid 1 and the remote input unit 2. The hearing aid 1 may be wirelessly connected to the external processing unit 3 to allow audio signals, control signals and/or information signals to be communicated between the bearing aid 1 and the external processing unit 3. The remote input unit 2 may be wirelessly connected to the external processing unit 3 to allow audio signals, control signals and/or information signals to be communicated between the remote input unit 2 and the external processing unit 3.

One or more processing units 14, 24, 34 of the hearing aid system are configured to obtain the plurality of local input audio signals. One or more processing units 14, 24, 34 of the hearing aid system are configured to obtain the remote audio signal. One or more processing units 14, 24, 34 of the hearing aid system are configured to beamform the plurality of local input audio signals to determine a front-facing beamformed signal. The front-facing beamformed signal is configured to focus on sound coming from a direction which the user of the hearing aid 1 is facing. One or more processing units 14, 24, 34 of the hearing aid system are configured to determine a prime candidate signal based on the front-facing beamformed signal and the remote audio signal. The prime candidate signal is a source separated audio signal derived from the remote audio signal and determined based on a similarity measure with the front-facing beamformed signal.

The processing performed by the one or more processing units 14, 24, 34 may be performed by the local processing unit 14 comprised by the hearing aid 1. The processing performed by the one or more processing units 14, 24, 34 may be performed by the remote processing unit 24 comprised by the remote input unit 2. The processing performed by the one or more processing units 14, 24, 34 may be performed partly by the remote processing unit 24 and partly by the local processing unit 14. If the hearing aid system comprises an external processing unit 3 the processing may be performed by the external processing unit 3. The processing may be distributed over processing units 14, 24, 34 comprised by the hearing aid system. To facilitate further processing of signals in the system signals may be transmitted between devices for further processing.

The one or more local processing units 14 may be configured to beamform the plurality of local input audio signals to determine the front-facing beamformed signal. The one or more local processing units 14 may be configured to down-sample the front-facing beamformed signal. The one or more local processing units 14 may be configured to down-sample the front-facing beamformed signal. The one or more local processing units 14 may be configured to transmit the down sampled front-facing beamformed signal to the one or more remote processing units 24. The one or more remote processing units 24 may be configured to obtain the remote audio signal. The one or more remote processing units 24 may be configured to obtain the remote audio signal. The one or more remote processing units 24 may be configured to obtain the down-sampled front-facing beamformed signal. The one or more remote processing units 24 may be configured to determine the prime candidate signal.

The one or more processing units 14, 24, 34 may be configured to source separate the remote input audio signal to determine a plurality of candidate signals. The one or more processing units 14, 24, 34 may be configured to determine for each candidate signal a similarity measure between the respective candidate signal and the front-facing beamformed signal. The one or more processing units 14, 24, 34 may be configured to determine the prime candidate signal from the plurality of candidate signals based on the plurality of similarity measures.

The remote input unit 2 may be configured to provide a plurality of remote audio signals. The one or more processing units 14, 24, 34 may be configured to obtain the plurality of remote audio signals. The one or more processing units 14, 24, 34 may be configured to source separate the plurality of remote audio signals by decomposing the plurality of remote audio signals using a spatial filter bank.

If a plurality of candidate signals is determined, the one or more processing units 14, 24, 34 may be configured to determine for each candidate signal a plurality of similarity measures between the respective candidate signal and the front-facing beamformed signal. The plurality of similarity measures may be determined by temporally shifting the front facing beamformed signal relative to the candidate signal a plurality of times and for each shift determining the similarity measure.

If a plurality of candidate signals is determined, the one or more processing units 14, 24, 34 may be configured to determine for each candidate signal the similarity measure between the candidate signal and the front-facing beamformed signal by determining a correlation measure between the respective candidate signal and the front-facing beamformed signal.

If a plurality of candidate signals is determined, the one or more processing units 14, 24, 34 may be configured to determine a local audio quality measure of the front-facing beamformed signal. The one or more processing units 14, 24, 34 may be configured to determine a remote audio quality for each candidate signal. The one or more processing units 14, 24, 34 may be configured to determine for each candidate signal the similarity measure between the respective candidate signal and the front-facing beamformed signal by comparing the local audio quality measure with the respective remote audio quality measure.

If a plurality of candidate signals is determined, the one or more processing units 14, 24, 34 may be configured to determine a plurality of prime candidate signals from the plurality of candidate signals based on the similarity measures.

If a plurality of prime candidate signals is determined, the one or more processing units 14, 24, 34 may be configured to output the plurality of prime candidate signal to the user of the hearing aid. The one or more processing units 14, 24, 34 may be configured to receive a user input from the user indicating a preferred prime candidate signal. The one or more processing units 14, 24, 34 may be configured to determine the preferred prime candidate signal based on the user input.

If a plurality of prime candidate signals is determined, the one or more processing units 14, 24, 34 may be configured to combine the plurality of prime candidate signals to determine a combined prime candidate signal. The plurality of prime candidate signals may be combined based on their respective similarity measure.

The one or more processing units 14, 24, 34 may be configured to determine the prime candidate signal by a neural network trained to source separate the remote audio signal. The neural network may be configured to obtain the front-facing beamformed signal as an enrollment signal.

The one or more processing units 14, 24, 34 may be configured to determine the output audio signal based on the prime candidate signal.

The processing performed by the one or more processing units 14, 24, 34 may be performed by any processing unit comprised by the hearing aid system. The processing performed by the one or more processing units 14, 24, 34 may be distributed throughout the one or more processing units comprised by the hearing aid system.

The hearing aid system may comprise a sensor 4. The sensor may be comprised as a separate device or be comprised by the hearing aid 1 or the remote input unit 2. If the sensor 4 is comprised as a separate device, the sensor 4 may comprise a sensor communication interface configured to wirelessly receive and transmit signals. The sensor 4 is configured to provide a sensor signal. The one or more processing units 14, 24, 34 may be configured to obtain the sensor signal. The one or more processing units 14, 24, 34 may be configured to determine the prime candidate signal based on the sensor signal.

The one or more local processing units 14 may be configured to obtain the prime candidate signal. The one or more local processing unit 14 may be configured to determine the output audio signal based on the prime candidate signal.

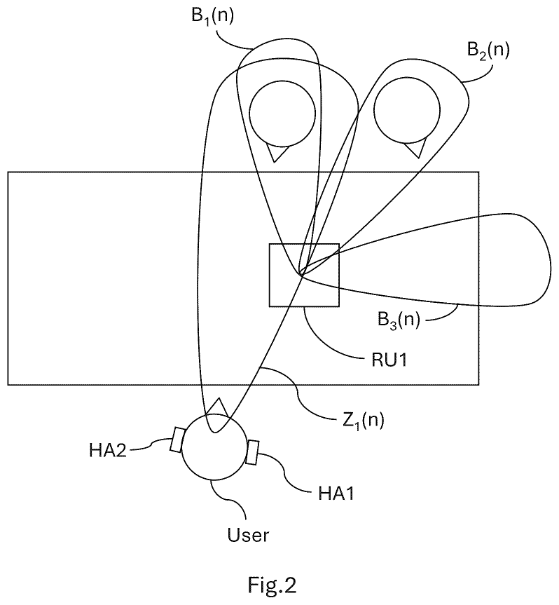

Referring to FIG. 2 which shows a hearing aid system according to the present disclosure employed in a meeting situation. In the presented meeting situation, a remote unit RU1 is deployed on a meeting table. Meeting participants are located around the table. One of the participants is a hearing aid user. The user is wearing a first hearing aid HA1 and a second hearing aid HA2. The remote unit RU1 presented in relation to FIG. 2 may be substantially the same as the remote unit 2 presented in relation to FIG. 1. The hearing aids HA1, HA2 presented in relation to FIG. 2 may each be substantially the same as the hearing aid 1 presented in relation to FIG. 1. The processing described in relation to FIG. 1 may be equally applicable and carried out by the hearing aid system presented on FIG. 2.

In the situation one or more processing units of the hearing aid system determines a front facing beamformed signal Z₁(n) based on a plurality of local input audio signals obtained by the first hearing aid HA1 and the second hearing aid 2, on the figure a main lobe of the front-facing beamformed signals is shown. The first hearing aid HA1 is configured to be worn at a first ear of the user. The second hearing aid HA2 is configured to be worn at a second ear of the user. The first hearing aid HA1 comprises a first local input interface configured to provide a plurality of first local input audio signals, a first output interface configured to output a first output audio signal to the user, and a first local communication interface configured to wirelessly transmit and obtain signals. The second hearing aid HA2 comprises a second local input interface configured to provide a plurality of second local input audio signals, a second output interface configured to output a second output audio signal, and a second local communication interface configured to wirelessly transmit and obtain signals. The one or more processing units may be configured to obtain the plurality of first local input audio signals. The one or more processing units may be configured to obtain the plurality of second local input audio signals. The one or more processing units may be configured to binaurally beamform the plurality of first local input audio signals and the plurality of second local input audio signals to determine the front-facing beamformed signal Z₁(n).

The one or more processing units are configured to determine a plurality of candidate signals B₁(n), B₂(n), B₃(n). The plurality of candidate signals B₁(n), B₂(n), B₃(n) are compared to the front-facing beamformed signal Z₁(n), and the candidate signal most similar to the front-facing beamformed signal Z₁(n) is determined as the prime candidate signal.

In the shown example, a hearing aid user is assumed to be trying to focus on speech coming from a person. The assumption in the present disclosure is that the hearing aid user will face towards the person of interest, hence, the person of interest will be within the main lobe of the front-facing beamformed signal Z₁(n). The remote unit may be placed closer to the person of interest as shown in FIG. 2, hence, one or more remote audio signals provided by the remote unit may exhibit a higher signal to noise ratio than for example the local audio signal obtained by the hearing aids HA1, HA2. Thus, it may be advantageous to instead utilize the remote audio signals for further processing or to deliver it directly to the hearing aid user instead of relying on the local audio signals.

In the situation depicted in FIG. 2 two candidate talkers are present for the hearing aid user. The remote input unit may be configured to source separate the sound field using a spatial filter bank, e.g., several beamformers pointing in different directions. The source separation of the sound field in present example leads to a number of candidate sound signals B₁(n), B₂(n), B₃(n). As mentioned, it is reasonable to assume that the HA user is interested in the candidate talker in front, because the HA user makes use of lip reading and, hence, tends to face the target talker. In the situation depicted in FIG. 2, it is in fact the candidate talker who is captured by candidate signal B₂(n) who is the target.

To decide automatically which of the candidate signals B₁(n), B₂(n), B₃(n) is the target, the front-facing beamformed signal Z₁(n) is determined. The front-facing beamformed signal is a beamformed signal determined from the local audio signals, which “points” forward. The basic idea for identifying the target is to choose the candidate signal B₁(n), B₂(n), B₃(n) which is most like the front-facing beam-formed signal Z₁(n) To identify the most similar signal a similarity measure between each candidate signal B₁(n), B₂(n), B₃(n) and the front-facing beamformed signal Z₁(n) may be determined. Then, the candidate signal Bᵢ₊(n) comprising the target may be assumed to be the one most similar to the front-facing beam-formed signal Z₁(n), and may be found mathematically as such:

$${i}^{*} = arg {max}_{i} S ( {B}_{i} ( n ) , Z ( n ) ) .$$

Where S(·) is a similarity measure.

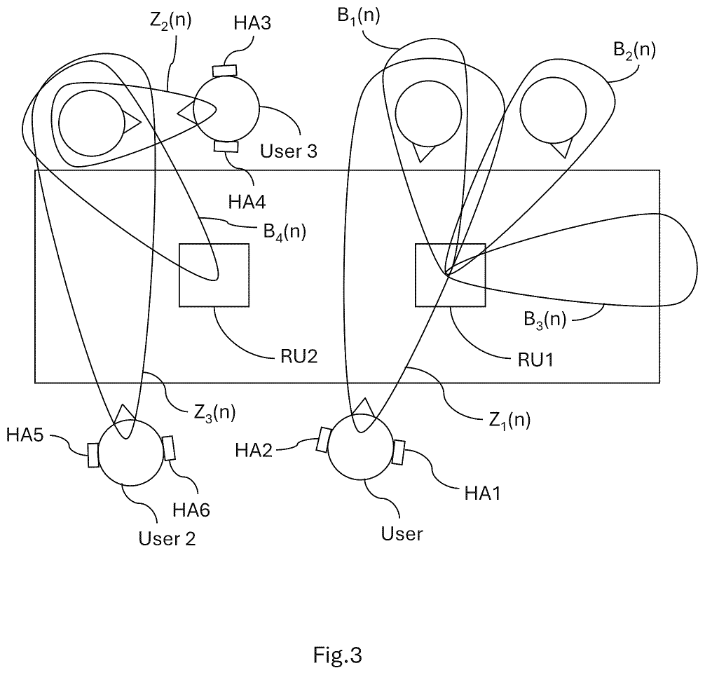

Referring to FIG. 3 which shows another hearing aid system according to the present disclosure employed in a meeting situation. The hearing aid system of FIG. 3 differs from that of FIG. 2 in that it comprises a second remote unit RU2, and a plurality of hearing aids HA1, HA2, HA3, HA4, HA5, HA6 worn by different users, user, user 1, user 2. The hearing aids HA1, HA2, HA3, HA4, HA5, HA6 and the remote units RU1, RU2 may be substantially similar to the remote unit and the hearing aid presented in relation to FIG. 1. Each of the plurality of hearing aids HA1, HA2, HA3, HA4, HA5, HA6 comprises a local input interface configured to provide a plurality of local input audio signals, an output interface configured to output an output audio signal to the user, and a local communication interface configured to wirelessly transmit and obtain signals. The one or more processing unit may be configured to obtain the plurality of local input audio signals from each of the plurality of hearing aids. The one or more processing unit may be configured to beamform each of the pluralities of local input audio signals to determine a plurality of front-facing beamformed signal. The one or more processing units may be configured to determine a prime candidate signal for each hearing aid based on the respective front-facing beamformed signals and the remote audio signal. Each prime candidate signal is a source separated audio signal derived from the remote audio signal and determined based on a similarity measure between the respective front-facing beamformed signal and the remote audio signal.

In the present example several hearing aid users are participating in the meeting, and each hearing aid user has their own front-facing beamformed signal Z₁(n), Z₂(n), Z₃(n). Furthermore, each the remote audio signal provided by the remote units RU1, RU2 may be used to determine separately to determine different candidate signals B₁(n), B₂(n), B₃(n), B₄(n) for the remote audio signals provided by the different remote units RU1, RU2. The front-facing beamformed signals Z₁(n), Z₂(n), Z₃(n) may be collected by one or more processing units together with determined candidate signals B₁(n), B₂(n), B₃(n), B₄(n). The front-facing beamformed signals Z₁(n), Z₂(n), Z₃(n) and the determined candidate signals B₁(n), B₂(n), B₃(n), B₄(n) may be collected in a superlist. The one or more processing units may then be configured to determine the prime candidate signal for each front-facing beamformed signal by determining which element of the super list provides the highest similarity measure. For example, in the shown example on FIG. 3, two hearing aids users, user 2 and user 3, are trying to listen to the same speaker. The hearing aid users are facing the speaker, therefore, their associated front-facing beamformed signals Z₂(n), Z₃(n) captures speech produced by the speaker. A candidate signal Ba (n) is also capturing speech from the user. The candidate signal B₄(n) is determined based on a remote audio signal provided by a second remote input unit RU2. For user 2 it may be advantageous to utilize the front-facing beamformed signal Z₃(n) determined based on the local audio signals obtained by the hearing aids HA3, HA4 worn by user 3 as the prime candidate signal for user 2, since user 3 is located closer to the speaker than the second remote unit 2.

It is intended that the structural features of the devices and systems described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure, or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A hearing aid system comprising:
a hearing aid configured to be worn by a user, the hearing aid comprising a local input interface configured to provide a plurality of local input audio signals, an output interface configured to output an output audio signal to the user, and a local communication interface configured to wirelessly transmit and receive signals,
A remote input unit comprising a remote input interface configured to provide a remote audio signal, and a remote communication interface configured to wirelessly transmit and receive signals,
one or more processing units configured to:
obtain the plurality of local input audio signals,
obtain the remote audio signal,
beamform the plurality of local input audio signals to determine a front-facing beamformed signal, wherein the front-facing beamformed signal is configured to focus on sound coming from a direction which the user of the hearing aid is facing,
determine a prime candidate signal based on the front-facing beamformed signal and the remote audio signal, wherein the prime candidate signal is a source separated audio signal derived from the remote audio signal and determined based on a similarity measure with the front-facing beamformed signal.

2. A hearing aid system according to claim 1, wherein the hearing aid system comprises:
a first hearing aid configured to be worn at a first ear and a second hearing aid configured to be worn at a second ear of the user, wherein the first hearing aid comprises a first local input interface configured to provide a plurality of first local input audio signals, a first output interface configured to output a first output audio signal to the user, and a first local communication interface configured to wirelessly transmit and obtain signals, wherein the second hearing aid comprises a second local input interface configured to provide a plurality of second local input audio signals, a second output interface configured to output a second output audio signal, and a second local communication interface configured to wirelessly transmit and obtain signals,
wherein the one or more processing units are configured to:
obtain the plurality of first local input audio signals,
obtain the plurality of second local input audio signals,
binaurally beamform the plurality of first local input audio signals and the plurality of second local input audio signals to determine the front-facing beamformed signal.

3. A hearing aid system according to claim 1, wherein the hearing aid comprises one or more local processing units configured to:
beamform the plurality of local input audio signals to determine the front-facing beamformed signal,
down-sample the front-facing beamformed signal, and
subsequent to down-sampling of the front-facing beamformed signal, transmit the front-facing beamformed signal to one or more remote processing units,
wherein the remote input unit comprises one or more remote processing units configured to:
obtain the remote audio signal,
obtain the down-sampled front-facing beamformed signal,
determine the prime candidate signal.

4. A hearing aid system according to claim 1, wherein the one or more processing units are configured to:
source separate the remote input audio signal to determine a plurality of candidate signals,
determine for each candidate signal a similarity measure between the respective candidate signal and the front-facing beamformed signal, and
determine the prime candidate signal from the plurality of candidate signals based on the plurality of similarity measures.

5. A hearing aid system according to claim 4, wherein the remote input unit is configured to provide a plurality of remote audio signals,
wherein the one or more processing units are configured to:
obtain the plurality of remote audio signals,
source separate the plurality of remote audio signals by decomposing the plurality of remote audio signals using a spatial filter bank.

6. A hearing aid system according to any of claim 4, wherein the one or more processing units are configured to:
determine for each candidate signal a plurality of similarity measures between the respective candidate signal and the front-facing beamformed signal, wherein the plurality of similarity measures is determined by temporally shifting the front facing beamformed signal relative to the candidate signal a plurality of times and for each shift determining the similarity measure.

7. A hearing aid system according to claim 4, wherein the one or more processing units are configured to:
determine for each candidate signal the similarity measure between the candidate signal and the front-facing beamformed signal by determining a correlation measure between the respective candidate signal and the front-facing beamformed signal.

8. A hearing aid system according to claim 4, wherein the one or more processing units are configured to:
determine a local audio quality measure of the front-facing beamformed signal,
determine a remote audio quality for each candidate signal, determine for each candidate signal the similarity measure between the respective candidate signal and the front-facing beamformed signal by comparing the local audio quality measure with the respective remote audio quality measure.

9. A hearing aid system according to claim 4, wherein the one or more processing unit are configured to:
determine a plurality of prime candidate signals from the plurality of candidate signals based on the similarity measures.

10. A hearing aid system according to claim 9, wherein the one or more processing unit are configured to:
output the plurality of prime candidate signal to the user of the hearing aid,
receiving a user input from the user indicating a preferred prime candidate signal,
determine the preferred prime candidate signal based on the user input.

11. A hearing aid system according to claim 9, wherein the one or more processing unit are configured to:
combine the plurality of prime candidate signals to determine a combined prime candidate signal, wherein the plurality of prime candidate signals is combined based on their respective similarity measure.

12. A hearing aid system according to claim 1, wherein the one or more processing units are configured to:
determine the prime candidate signal by a neural network trained to source separate the remote audio signal, wherein the neural network is configured to obtain the front-facing beamformed signal as an enrollment signal.

13. A hearing aid system according to claim 1 comprising:
a sensor configured to provide a sensor signal,
wherein the one or more processing units are configured to:
obtain the sensor signal,
determine the prime candidate signal based on the sensor signal.

14. A hearing aid system according to claim 1, wherein the one or more processing units are configured to:
determine the output audio signal based on the prime candidate signal.

15. A hearing aid system according to claim 1, comprising a plurality of hearing aids configured to be worn by a plurality of users, the plurality of hearing aids each comprising a local input interface configured to provide a plurality of local input audio signals, an output interface configured to output an output audio signal to the user of the respective hearing aid, and a local communication interface configured to wirelessly transmit and obtain signals,
wherein the one or more processing units are configured to:
obtain the plurality of local input audio signals from each of the plurality of hearing aids,
beamform each of the pluralities of local input audio signals to determine a plurality of front-facing beamformed signals,
determine a prime candidate signal for each hearing aid based on the front-facing beamformed signals and the remote audio signal, wherein each prime candidate signal is a source separated audio signal derived from the remote audio signal and determined based on a similarity measure between the respective front-facing beamformed signal and the remote audio signal.

16. A hearing aid system according to claim 1, wherein the hearing aid comprises one or more local processing units configured to:
obtain the prime candidate signal, and
determine the output audio signal based on the prime candidate signal.

17. A method for determining an audio signal of interest comprising:
obtaining a plurality of local input audio signals provided by a hearing aid,
obtaining a remote audio signal provided by a remote input unit,
beamforming the plurality of local input audio signals to determine a front-facing beamformed signal, wherein the front-facing beamformed signal is determined to focus on sound coming from a direction which the user of the hearing aid is facing,
determining a prime candidate signal based on the front-facing beamformed signal and the remote audio signal. wherein the prime candidate signal is a source separated audio signal derived from the remote audio signal and determined based on a similarity measure with the front-facing beamformed signal.
